(19) United States
(12) Patent Application Publication
(10) Pub. No.: US 2011/0143070 A1
(43) Pub. Date: Jun. 16, 2011

(54) THERMO-MECHANICALLY STABLE, HEAT SEALABLE FILM, A BARRIER COATED SUCH FILM, A PACKAGING LAMINATE COMPRISING THE FILM, A PACKAGING CONTAINER FORMED FROM THE PACKAGING LAMINATE AND A METHOD FOR THE PRODUCTION OF THE FILM

(75) Inventors: Nils Toft, Lund (SE); Bertrand Jaccoud, Siviriez (CH); André Chiquet, Givisiez (CH); Gil Rochat, Mezieres (CH); Pierre Fayet, Lausanne (CH); Alain Bonnébault, Saillon (CH); Walker Camacho, Skarholmen (SE)

(73) Assignee: Tetra Laval Holdings & Finance S.A., Avenue General-Guisan 70 (CH)

(21) Appl. No.: 12/922,641

(22) PCT Filed: Mar. 12, 2009
(86) PCT No.: PCT/EP2009/001767

§ 371 Date: Mar. 1, 2011

(30) Foreign Application Priority Data
Mar. 14, 2008 (SE) 0800605-8

(51) Int. Cl. B32B 1/02; B32B 5/00; B29C 47/00; B29C 55/04; B05D 1/00; B05D 3/04

(52) U.S. Cl. 428/36.92; 428/220; 428/337; 264/210.1; 427/248.1; 427/250; 427/569

(57) ABSTRACT

A thermo-mechanically stable, heat sealable mono-axially oriented polymer substrate film includes polymers based on low density polyethylene. The thermo-mechanically stable, heat sealable mono-axially oriented polymer substrate film can consist essentially of the polymers based on low density polyethylene. The disclosure also describes a vapour deposition coated substrate film, especially such a film which is metallised, a packaging laminate comprising the vapour deposition coated polymer substrate film, and a packaging container produced from such a packaging laminate. Also disclosed is a method for the production of the thermo-mechanically stable, heat sealable polymer substrate film and a method of vapour deposition coating the film.

### TECHNICAL FIELD OF THE INVENTION

The present invention relates to a thermo-mechanically stable, heat sealable mono-axially oriented polymer substrate film (12), consisting of polymers based on low density polyethylene. The invention further relates to such a vapour deposition coated substrate film, especially a metallised such film. The invention also relates to a packaging laminate comprising the vapour deposition coated polymer substrate film and to a packaging container produced from such a packaging laminate. The invention further relates to a method for the production of the thermo-mechanically stable, heat sealable polymer substrate film and to the method of vapour deposition coating the film.

### BACKGROUND OF THE INVENTION

Packaging containers of the single use disposable type for liquid foods are often produced from a packaging laminate based on paperboard or carton. One such commonly occurring packaging container is marketed under the trademark Tetra Brik Aseptic® and is principally employed for aseptic packaging of liquid foods such as milk, fruit juices etc, sold for long term ambient storage. The packaging material in this known packaging container is typically a laminate comprising a bulk core layer of paper or paperboard and outer, liquid-tight layers of thermoplastics. In order to render the packaging container gas-tight, in particular oxygen gas-tight, for example for the purpose of aseptic packaging and packaging of milk or fruit juice, the laminate in these packaging containers normally comprises at least one additional layer, most commonly an aluminium foil.

On the inside of the laminate, i.e. the side intended to face the filled food contents of a container produced from the laminate, there is an innermost layer, applied onto the aluminium foil, which innermost, inside layer may be composed of one or several part layers, comprising heat sealable adhesive polymers and/or polyolefins. Also on the outside of the core layer, there is an outermost heat sealable polymer layer. The heat-sealable polymer layers are preferably based on low density polyethylenes.

The packaging containers are generally produced by means of modern, high-speed packaging machines of the type that continuously form, fill and seal packages from a web or from prefabricated blanks of packaging material, e.g. Tetra Brik Aseptic®-type packaging machines. Packaging containers may thus be produced by reforming a web of the laminated packaging material into a tube by both of the longitudinal edges of the web being united to each other in an overlap joint by welding together the inner- and outermost heat sealable thermoplastic polymer layers. The tube is filled with the intended liquid food product and is thereafter divided into individual packages by repeated transversal seals of the tube at a predetermined distance from each other below the level of the contents in the tube. The packages are separated from the tube by incisions along the transversal seals and are given the desired geometric configuration, normally parallelepipedic, by fold formation along prepared crease lines in the packaging material.

The main advantage of this continuous tube-forming, filling and sealing packaging method concept is that the web may be sterilised continuously just before tube-forming, thus providing for the possibility of an aseptic packaging method, i.e. a method wherein the liquid content to be filled as well as the packaging material itself are reduced from bacteria and the filled packaging container is produced under clean circumstances such that the filled package may be stored for a long time even at ambient temperature, without the risk of growth of micro-organisms in the filled product. Another important advantage of the Tetra Brik®-type packaging method is, as stated above, the possibility of continuous high-speed packaging, which has considerable impact on cost efficiency.

A layer of an aluminium foil in the packaging laminate provides barrier properties quite superior to most polymeric barrier materials. The conventional aluminium-foil based packaging laminate for liquid food aseptic packaging is the most cost-efficient packaging material, at its level of performance, available on the market today. Any other material to compete must be more cost-efficient regarding raw materials, have comparable food preserving properties and have a comparably low complexity in the conversion into a finished packaging laminate.

Hitherto, there are hardly any aseptic paper- or paperboard-based packages for long-term ambient storage of the above described kind available on the market, from a cost-efficient, non-foil packaging laminate, as compared to aluminium-foil laminates, that have a reliable level of barrier properties and food preservation properties for more than 3 months.

Among the efforts of developing more cost-efficient packaging materials and minimizing the amount of raw material needed for the manufacturing of packaging materials, there is a general incentive towards developing pre-manufactured films having multiple barrier functionalities, which may replace the aluminium-foil. Previously known such examples are films combining multiple layers, which each contribute with complementing barrier properties to the final film, such as for example films having a vapour deposited barrier layer and a further polymer-based barrier layer coated onto the same substrate film. Such films, which have been coated at least two times with different coating methods, tend, however, to become very expensive and involve very high demands on the qualities of the substrate film, such as thermal resistance and handling durability.

On the other hand, to optimise the packaging laminate, the production of the same and the packaging container, there is an incentive, in addition to lowering the raw material costs, to simplify the structure of the packaging laminate, to decrease the number of conversion steps needed and to provide a packaging laminate that has sufficient barrier and food preserving properties.

Another, method of including two functionalities in the same film, is to include a heat sealable layer for heat sealing of a packaging material in the film on a first side, and a barrier layer on the other side. One example of such a film is known from the earlier filed International patent application No. WO-A-2006/027662, which describes a polymer film comprising a gas barrier coating of SiOx coated onto a first side of a polymer carrier layer having also a polyolefin layer arranged on a second side of said polymer carrier layer. It further describes packaging laminates made therefrom and packaging containers wherein the heat sealable polyolefin layer is in direct contact with the contents thereof. It discloses also, a method for the production of a polymer film comprising a gas barrier coating of SiOx, which method comprises the steps of:

a) forming a polymer carrier layer and a heat sealable polyolefin layer, and joining these layers together to form an intermediate film;
b) directly applying said coating of SiOx onto said polymer carrier layer, to form said film,
and preferably, after step (a) but before step (b), an intermediate step of orienting, preferably mono-orienting, said intermediate film by stretching.

The polymer carrier layer is exemplified as a polyamide- or a polyester-based polymer, preferably a polyamide, because it adds some barrier properties itself and provides a good receiving surface and thermo-mechanical properties for subsequent coating with SiOx.

Such a SiOx-coated film is, however, more difficult to manufacture in that the film incorporates two such different types of polymers as polyamide or polyester on the one side of the carrier layer film, and polyethylene on the other side of the film, which results in tensions and less compatible thermal behaviour between the layers within the film. This puts high demands on the manufacturing process in order to provide sufficiently reliant barrier and integrity properties and does, contrary to what was intended, add quite some complexity in the material conversion process as a whole.

### OBJECT OF THE INVENTION

It is therefore an objective of the present invention to provide a thermo-mechanically stable, mono-axially oriented heat sealable polymer substrate film for vapour deposition coating and a packaging laminate that helps to alleviate the above discussed disadvantages and problems and which fulfil at least some of the above requirements, preferably all of them.

Accordingly, it is an objective of the present invention to provide a thin, pre-manufactured, thermo-mechanically stable and heat sealable polymer substrate film for vapour deposition coating of a barrier layer, suitable for use in a packaging laminate/container, which vapour deposition coated substrate film combines a desired barrier property, such as gas barrier, water vapour barrier or non-scalping barrier property, a heat sealing layer included in the polymer substrate film, a high strength, an improved runnability in coating or laminating the film, and lower costs.

The packaging laminate comprising the vapour deposition coated heat sealable polymer substrate film should preferably be suitable for aseptic packaging and long-term storage, and have sufficient bending stiffness to be suitable for continuous, high speed packaging of liquid foods by means of a continuous tube-forming method.

The invention is also directed to a packaging container filled with solid, semi-solid or liquid food or beverage and produced from the packaging laminate comprising the heat sealable polymer substrate film.

These and other objectives are achieved by means of the thermo-mechanically stable, heat sealable polymer substrate film for vapour deposition coating of a barrier layer, the packaging laminate and the packaging container employing said film, and by the method for the production of the vapour deposition coated, thermo-mechanically stable, heat sealable polymer substrate film according to the invention, as defined in the appended claims.

Accordingly, the present invention provides a thermo-mechanically stable, heat sealable, mono-axially oriented polymer substrate film, substantially consisting of polymers based on lower density polyethylenes, wherein the polymer substrate film has a thickness of 20 μm or lower, preferably 15 μm or lower, shrink properties of 15% or lower, preferably 12% or lower, based on ASTM D 1204 at 80° C. measurement temperature, and a Young's Modulus of from 250 to 800 MPa, preferably from 300 to 500 MPA, more preferably from 300 to 400 MPa. The polymer substrate film substantially consists of lower density polyethylenes, which means that only a minor amount of other polymers are included in the film core, i.e. less than 20 weight-% of a different polymer, such as for example high or medium density polyethylenes (HDPE or MDPE, respectively) or polypropylene, preferably less than 10 weight-%, more preferably less than 5 weight-% a different polymer. Most preferably, the polymer substrate film consists of lower density polyethylenes only.

Preferably, the total thickness of the mono-oriented layers of said substrate film is from 10 to 20 μm, preferably from 12 to 18, more preferably from 14 to 16 μm.

It is to be understood hereinafter that the thicknesses given for the various layers of the multilayer film are the thicknesses obtained after stretching for orientation of the intermediate, laminated, multilayer film.

Preferably, the heat sealable polymer substrate film comprises at least one layer of a material in the group that consists of linear low density polyethylene (LLDPE), or metallocene-polymerised LLDPE, in combination with up to 25, preferably up to 20, weight-% of a conventional low density polyethylene (LDPE), based on the total weight of the polymer substrate film.

Preferably, the polymer substrate film is a film from multiple, preferably up to seven, more preferably op to five, layers of the same basic low density polyethylene material, which multiple layers each are mono-oriented in the same direction and to the same extent. Here, it should be understood that e.g. low density polyethylene materials of all grades, including e.g. metallocene polyethylene (M-LLDPE), low density polyethylene-based copolymers, as well as low density (LDPE), linear low density (LLDPE) etc., are considered to be materials of the same basic low density polyethylene material.

LDPE's and LLDPE's are generally known as good heat sealable materials, the LLDPE's being better in heat sealability than LDPE. None of these polymers are however known to be thermo-mechanically stable in the form of films, i.e. capable of withstanding thermal strain or heat load, such as from coating and lamination processes involving heat supply to such substrate film materials. Since the material is generally soft and unstable for use in substrate films, higher thicknesses are required, which of course increases costs. By orientating such films based on lower density polyethylenes, the amount of material used in the films may be kept lower and the stiffness and handling properties of the film may be improved.

Preferably, the polymer substrate film is oriented to a ratio of 2-7, preferably from 2-4, more preferably from 2-3 and, preferably, the polymer substrate film then gets an elongation at break lower than 400%, preferably lower than 300%, more preferably lower than 200%.

Thus, Young's modulus varies from about 250-300 MPa at an orientation ratio of 2, to up to 700-800 MPa for an orientation ratio of about 6-7. Elongation at break decreases from about 400% to lower than 100% when increasing the ratio from 2 to 7.

Generally, Young's Modulus increases with the orientation ratio, while the elongation at break decreases with the orientation ratio. A good film has been developed at an orientation ratio of about 3, resulting in a film which provides for good elasticity, strength and integrity in a packaging container manufactured from a packaging laminate comprising the film at its innermost side. Using other types and grades of low density polyethylenes, higher orientation ratios may alternatively be preferred. Generally, however, it is believed that at too low elongation at break and too high youngs Modulus, the stiffness and strength properties of the film will affect the integrity and openability of a packaging container made from the packaging laminate negatively. By package integrity is meant the capability of the various layers in the laminate to remain intact and in adhesive contact with each other and also the capability of the packaging container to stay intact, without leaking, when subjected to environmental and mechanical strain, such as long-term storage, transport and difficult climate conditions. For example the quality of the seals of the packaging container is very important for the package integrity.

The thermo-mechanically stable polymer substrate film according to the invention is particularly suitable for being vapour deposition coated, on one side of the film.

According to a preferred embodiment the vapour deposited layer is a layer of thin metal or metal oxide, especially a metallised layer. Preferably, it is a layer of vapour deposited aluminium or aluminium oxide.

Preferably, the metallised layer has an optical density (OD) of from 1.8 to 3.0, preferably from 2.0 to 2.7, more preferably from 2.2 to 2.6. At an optical density lower than 1.8, the barrier properties of the metallised film are too low. At above 3.0, on the other hand, the metallisation layer becomes too brittle, and the thermostability during the metallisation process will be too low due to higher heat load when metallising the substrate film during a longer time. The coating quality and adhesion will then be clearly negatively affected. An optimum has, thus, been found between these values, preferably between 2.0 and 2.7.

Generally, the vapour deposition coating of a barrier layer onto the polymer substrate film in step (d), is carried out by means of a continuous method of physical or chemical vapour deposition. Various coatings of ceramic or metal composition may be applied by this type of methods. Generally, the thickness of such vapour deposited coatings may vary between 5 and 200 nm. Below 5 nm the barrier properties may be too low to be useful and above 200 nm, the coating is less flexible and, thus, more prone to cracking when applied onto a flexible substrate.

A metallisation layer, or ceramic layer, consisting of a thin coating comprising a metal or metal oxide, is preferably applied by means of vacuum deposition, but may less preferably be applied also by other methods generally known in the art having a lower productivity, such as electroplating or sputtering. The most preferred metal according to the present invention is aluminium, although any other metal capable of being vacuum deposited, electroplated or sputtered may be used according to the invention. Thus, less preferred and less common metals such as Au, Ag, Cr, Zn, Ti or Cu are conceivable also. Generally, thin coatings of pure metal or a mixture of metal and metal oxide provide barrier properties against water vapour and are used when the desired function is to prevent water vapour from migrating into and through the multilayer film or packaging laminate. Most preferably, the metal in a metallisation coating is aluminium (Al).

Preferred examples of ceramic coatings suitable as functional coatings according to the invention are SiOx coatings also containing carbon in their formula and AlOx coatings, MgOx coatings also being conceivable. This type of coatings provide gas barrier properties to the coated multilayer film as well as some degree of water vapour barrier properties, and are transparent coatings, which may be preferred in some cases.

One preferred coating is a coating of aluminium oxide having the formula AlOx wherein x varies from 1.0 to 1.5, preferably of Al₂O₃. Preferably, the thickness of such a coating is from 5 to 100 nm, preferably from 5 to 30 nm.

Preferably, these ceramic coatings are applied by means of physical vapour deposition (PVD) or reactive evaporation deposition or by a plasma enhanced chemical vapour deposition method (PECVD), wherein metal or silicon vapour is deposited onto the substrate under oxidising circumstances, thus forming an amorphous metal oxide or silicon oxide layer.

Other preferred silicon oxide-based coatings, are SiOxCy and SiOₓC_{y}N_{z} coatings. Such coatings often provide good gas barrier properties, and in some cases also water vapour barrier properties.

Alternatively, according to the invention, the vapour deposition coating may be an organic vapour deposited barrier, such as a vapour deposition coated thin carbon-based layer. Such carbon-based layers may be coated by means of a plasma coating process, resulting in a hydrocarbon polymer coating, referred to as amorphous carbon or diamond-like carbon (DLC) coatings.

According to a preferred embodiment of the vapour deposition coated polymer substrate film of the invention, the polymer substrate film has a thin receiving layer (13) towards the vapour deposition coated layer, which receiving layer preferably comprises a polyethylene-based adhesive polymer modified by graft- or co-polymerisation with monomers comprising functional groups selected from the group consisting of acrylic acid groups, methacrylic acid groups or maleic anhydride groups, more preferably an ethylene-acrylic acid co-polymer (EAA) or an ethylene-methacrylic acid co-polymer (EMAA), and which contact layer is mono-oriented in the same direction and to the same extent as any other layer(s) of the polymer substrate film. Such a receiving layer improves considerably the adhesion and cohesion of a vapour deposited, especially metallised, layer applied onto the polymer substrate film. High adhesion of the metallised layer to the substrate film is needed in order to stay intact and unaffected during heat extrusion lamination with further layers into a packaging laminate and in order to provide sufficient integrity properties in a finished packaging container manufactured from the packaging laminate.

The thickness of the receiving layer is from about 0.5 to 5, preferably from 1 to 3 μm.

In order to provide sufficient integrity of a packaging container produced from a vapour deposition coated, especially metallised, film according to the invention, the vapour deposition coated layer has an adhesion of at least 200, preferably at least 300 N/m (according to the AIMCAL test method for adhesion of metallised layers).

The sufficient adhesion is obtained partly by means of ion bombardment in a surface treatment process, in order to activate the surface before vapour deposition, especially metallisation, coating. Possible such surface activation treatments are corona and plasma treatments. Plasma surface treatment is preferred since it is possible to carry out in connection with the metallisation process and because it provided excellent surface properties for subsequent vapour deposition coating. Regarding some combinations of types of skin receiving layer polymers and vapour deposition coatings, even surface treatment by flame could be preferred.

Preferably, a metallised film according to the invention has an oxygen transmission rate lower than 100 cm³/(m²*24 h), 1 atm O₂, 23° C., 50% RH, and a water vapour permeation rate of lower than 5, preferably lower than 1 g/m² at 38 (and 23)° C., 24 hours, at a gradient of from 0 to 90% RH.

The oxygen transmission was tested in a Mocon 2/20 at 20% oxygen and corrected by a factor 5, to 100% oxygen. For determining the water vapour barrier, a method based on ASTM F-1249-06, using a modulated Infrared sensor for relative humidity detection and WVTR measurement, was used.

Thus, the thermo-mechanically stable polymer substrate film, onto which the vapour deposition coated layer is applied, i.e. the film consisting of heat sealable low density ethylene-based polymer, is a mono-oriented film. As shall be further described below, this can be achieved by mono-axial stretching of the film such that its thickness is reduced, before the vapour deposited layer is applied onto it. It has been found that an oriented polymer film, especially a mono-oriented polymer film, as compared to a non-oriented polymer film, has a lower elongation at break and a higher Young's Modulus. The lower elongation at break and higher Young's Modulus enables improved runnability in heat-generating coating or lamination methods, due to the film being more stable, especially more heat stable.

When producing the multilayer film of the invention, a problem which is overcome by the present invention, is that when stretching the quite thin films at high stretch ratios, the film web is sensitive to breaking. Conventional mono-axial stretching equipment usually involve an arrangement with only a couple of, or only a few, quite big rollers for the whole stretching operation. When seeking to overcome the above mentioned difficulties, it has been found that a higher number of smaller rollers, such as at least 10 rollers, preferably at least 15 rollers, provides a more flexible orientating and relaxation operation, with smoother stretching over the rollers, such that the risk for web breaking is decreased. Such orientation with multiple, idle rollers also enables higher orientation process speed, due to the larger number of orientation gaps.

Generally, a mono-oriented film may have the advantages over a non-oriented film of increased heat stability as well as having stiffness properties in the machine direction while also being more flexible in the cross direction, which is advantageous in the coating operation when applying a vapour deposition coating onto the substrate film, in a further method of laminating the mono-oriented polymer film into a packaging laminate and in the forming of a packaging container from a packaging laminate including the multilayer film. This may be expressed in terms of lower elongation at break and higher Young's modulus.

Suitably, the innermost heat sealable LDPE-based layer or part-layer may comprise a metallocene catalysed LLDPE, on the side of the film/laminate that is intended to face the interior of the packaging container to be formed from the laminate.

Optionally, the multiple layers of the substrate film may be bonded to each other by binding layer(s) between part-layers of the polymer substrate layer, which binding layer(s) is mono-oriented in the same direction as the rest of the heat sealable substrate film. Said binding layer then preferably consists of a polymer based on low density polyethylene or linear low density polyethylene which is modified by graft- or copolymerisation, and may have a thickness of from 0.5 to 2 μm.

Examples of binding layers are polymers based on LDPE or LLDPE copolymers or, preferably, graft copolymers with monomers comprising carboxylic or glycidyl functional groups, such as acrylic monomers or maleic anhydride (MAH) monomers, for example ethylene acrylic acid copolymer (EAA) or ethylene methacrylic acid copolymer (EMAA), ethylene-glycidyl(meth)acrylate copolymer (EG(M)A) or MAH-grafted polyethylene (MAH-g-PE).

The invention also relates to a packaging laminate comprising a film according to the invention. The packaging laminate further comprises a paper or paperboard bulk layer arranged to provide for the greatest contribution to the flexural rigidity of the laminate. It is however also conceivable that the bulk or core layer of the laminate instead is a polyolefin bulk layer, made e.g. of poly-ethylene, polypropylene or copolymers of ethylene, such as, for example, ethylene-propylene, ethylene-butene, ethylene-hexene, ethylene-alkyl(meth)-acrylate or ethylene-vinyl acetate copolymers. The choice of the material for such a polyolefin core layer may provide for a transparent packaging laminate, to be used e.g. in a transparent pouch for food.

It is intended that the heat sealable polyolefin layer of the pre-manufactured film forms a free surface of the packaging laminate, which surface is intended for food contact, as it directly faces the interior of a packaging container formed from the packaging laminate to be filled with a food product. However, it may be conceived, although less preferred, that one or more additional heat sealable layers is/are applied onto the film in connection with its incorporation in the packaging laminate, in which case the outermost additional heat sealable layer on the inside of the container is intended for direct food contact.

Furthermore, the packaging laminate comprises one or more outer heat sealable polyolefin layer(s) arranged on an opposite side of the bulk or core layer. Such outer heat sealable polyolefin layer(s) will directly face the surrounding environment of the packaging container.

The packaging container formed from the packaging laminate according to the invention may be of any known shape. Preferably, it is a brick- or wedge-shaped container that is durable at handling and distribution and resistant to moisture and oxygen gas during long term storage, due to the high quality packaging laminate, which in turn also provides for high seal quality and excellent gas barrier properties. A further important advantage of packaging containers produced from the packaging laminate according to the invention is that they may be durable to microwave cooking or thawing. Alternatively, a packaging container may be of the type pillow-shaped fiber pouch such as the packaging container known under the trademark Tetra Fino®.

A method for the manufacturing of a thermo-mechanically stable, heat sealable, mono-axially oriented polymer substrate film comprises the steps of:

a) forming a polymer substrate film from one or multiple layers substantially consisting of polymers based on low density polyethylene, and preferably comprising from 75 to 100 weight-% of linear low density polyethylene (LLDPE), by means of an extrusion manufacturing method,
b) mono-axially stretching the polymer substrate film to a ratio of 2-7, preferably 2-4, and to a thickness of below 20 μm, preferably below 15 μm.

A method for the manufacturing of a vapour deposition coated, thermo-mechanically stable, mono-axially oriented film comprising a vapour deposition coated layer and a heat sealable polymer substrate film, comprises the steps of:

a) forming a polymer substrate film from one or multiple layers substantially consisting of polymers based on low density polyethylene, by means of an extrusion manufacturing method,
b) mono-axially orientating the polymer substrate film to a ratio of 2-7, preferably 2-4 and to a thickness of below 20 μm, preferably below 15 μm,
c) surface treating a first side of the polymer substrate film, and subsequently,
d) vapour depositing a barrier layer from an inorganic or organic compound onto the first side of the film, which has been subject to said surface treatment.

According to one aspect of the method according to the invention, said polymer substrate film is formed in step (a) by an extrusion film casting or extrusion film blowing method, or in the case of multiple layers in the polymer substrate film, a co-extrusion casting or co-extrusion blowing manufacturing method.

Preferably, a thickness of the film is reduced by from 50 to 85%, preferably by 55-70%, by said stretching. Another way of expressing this is that in a preferred embodiment, the thickness of the film is preferably reduced from 35-40 μm, to 10-20 μm, more preferably from 36-38 to 12-16 μm. The invention is however not limited to those thicknesses, but other ranges are conceivable. Yet another way of defining the stretching is that the elongation at break of the film is reduced from usually being higher than 500%, to being lower than 400%, preferably lower than 300%, more preferably lower than 200%, by said stretching, or that the Young's Modulus of the film is increased to a value of from 250 to 800 MPa, preferably from 300 to 500 MPa, more preferably from 300 to 400 MPa, by said stretching. The increase of the Young's Modulus improves runnability in the step of vapour deposition coating onto the polymer substrate film or laminating the coated film into a packaging laminate.

Preferably, the step of mono-axially orientating the polymer substrate film is carried out by means of a combined orientating and relaxation method involving more than 10, preferably more than 15, orientation roller nips, of which the first and the last nips include driven rollers and the rollers there between are non-driven, idle rollers. By this method, stretching and relaxation takes place during the process where the tensions within the film allow and require it, without breaking the web, by help of the multiple idle running stretching rollers. By this method, the speed of the orientation process may be increased to further increase cost-efficiency of the mono-oriented film substrate.

Thus, for the purpose of working the invention, an apparatus is used for mono-orienting the polymer web of the invention, the apparatus comprising a path for receiving and stretching a polymer web, said path being defined by a first pair of driven rollers forming a nip for regulating the speed of advance of the unstretched polymer web, a series of at least 10 web stretching rollers defining a serpentine path, and a second pair of driven rollers forming a nip for regulating the speed of advance of the web after stretching, means being provided for driving at least the second pair of rollers for advancing a said polymer web through the apparatus at a speed of advance greater than that provided by said first pair of rollers. The intermediary stretching rollers are non-driven, i.e. they are not regulated to run at certain speed, but allowed to run idle, i.e. at a speed self-adaptable to the rest of the stretching operation.

Preferably, the idle, non-driven rollers have a smaller diameter of between 5 and 20 cm, depending on the material and quality of the rollers. Such a smaller diameter is preferable to avoid that the rollers have high too high inertia of movement, but should still be big enough to allow proper thermal transfer.

Preferably, and especially, when a polymer adhesive receiving layer for contacting the vapour deposition coating is used, the mono-orientation rollers are provided with a non-stick coating for improved orientation and relaxation during the mono-axial orientating step b). Such non-stick coatings of the rollers must be heat and wear resistant in order to withstand the mono-orientation process conditions. Also, in general such coated rollers increase the processability of a low density polyethylene-based film in the mono-orientation step.

### DESCRIPTION OF THE DRAWINGS

Further advantages and favourable characterising features of the present invention will be apparent from the following detailed description, with reference to the appended figures, in which:

FIG. 1a is a cross-sectional view of a preferred thermo-mechanically stable, heat sealable polymer substrate film according to the present invention,

FIG. 1b is a cross-sectional view of a vapour deposition coated polymer substrate film according to the present invention,

FIG. 2a is a cross-sectional view of a laminated packaging material according to the present invention, including a vapour deposition coated heat sealable polymer film according to the invention, as described in connection with FIG. 1b,

FIG. 2b shows how the packaging laminate exemplified in FIG. 2a may be manufactured according to the invention,

FIG. 3 is a diagrammatic view of a plant for co-extrusion blowing and stretching of an intermediate film,

FIG. 4 is a diagrammatic view of a plant for metal or metal oxide coating of the polymer substrate film produced in FIG. 1a.

FIG. 5a shows an example of a packaging container produced from the packaging laminate according to the invention,

FIG. 5b shows a second example of a packaging container produced from the packaging laminate according to the invention, and

FIG. 6 shows the principle of how such packaging containers are manufactured from the packaging laminate in a continuous forming, filling and sealing process.

### DESCRIPTION OF PREFERRED EMBODIMENTS

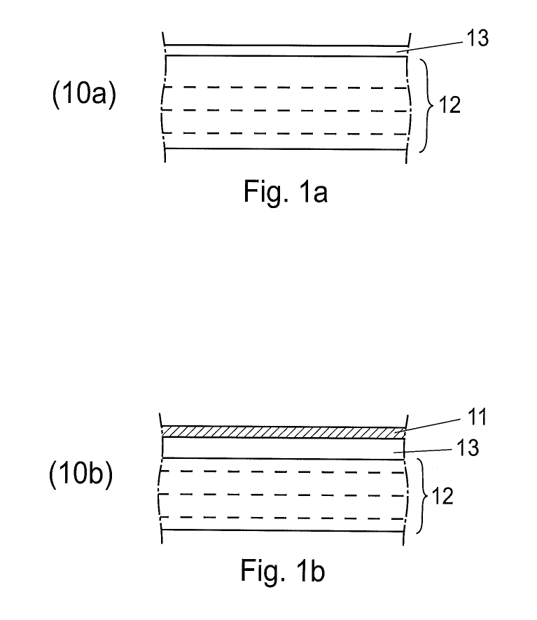

FIG. 1a shows a thermo-mechanically stable, heat sealable polymer substrate film 10a, composed of a heat-sealable low density polyethylene-based layer or multiple layers 12, of an LLDPE having a density of from 0.915 to 0.925, and a coating receiving layer 13, onto which a thin vapour deposition layer having the function of a barrier layer 11, especially a metallised layer of aluminium, is to be coated. The total thickness of the polymersusbtrate film 10a is about 15 μm and the thickness of the receiving layer is about 2 μm. The film has lower shrink than 15%, preferably lower than 12%, and a Young's Modulus of about 300 MPa.

FIG. 1b shows a vapour deposition coated thermo-mechanically stable and heat sealable film 10b, which is achieved by vapour deposition coating an aluminium metal coating onto the receiving layer 13 of the polymer substrate film of FIG. 1a. The aluminium metallisation layer 11 has an optical density of from about 2.0 to about 2.7.

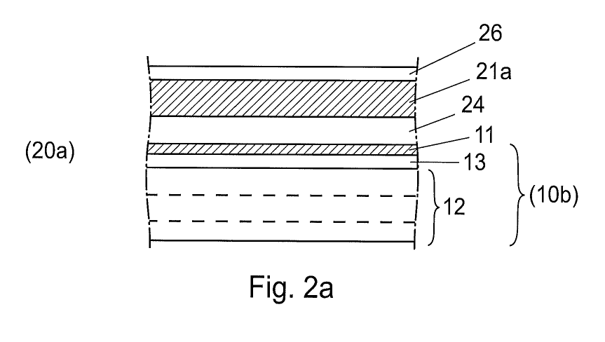

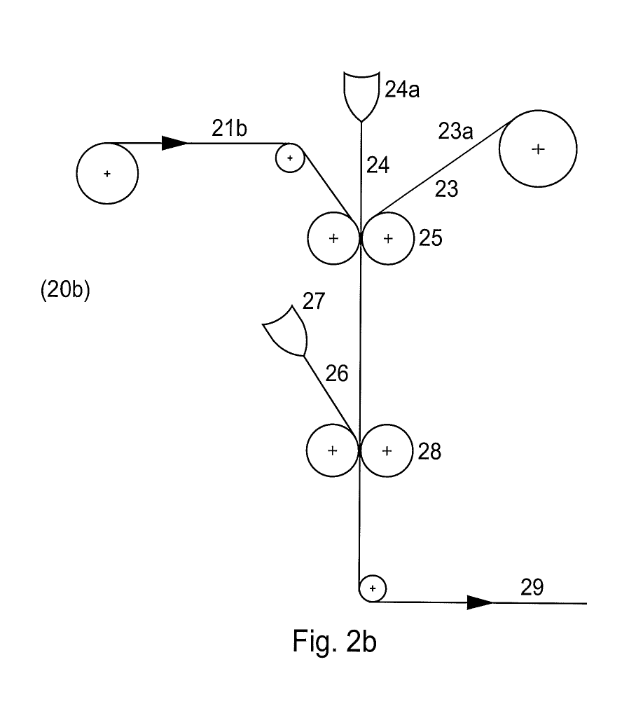

FIG. 2a shows a packaging laminate 20a, comprising a vapour deposition coated film 10b as described in FIG. 1b, laminated by means of at least one intermediate bonding layer 24 to a bulk paper or paperboard layer 21a. The intermediate bonding layer is preferably a thermoplastic polymer extrusion lamination layer and may include one or more additional layers such as for example thermoplastic polymer barrier layers. The layers may then be co-extruded together in the operation of laminating the film 10b and the paperboard layer 21a together. Alternatively, there may be a barrier layer coated or pre-laminated onto the paperboard, before lamination to the heat sealable barrier film 10b.

The thickest layer in the laminate is a bulk paper or paperboard layer 21a. Any paper or paperboard suitable for liquid carton-based packaging may be employed for the bulk layer 21a. It should be noted that the laminate layers in FIG. 2a do not reflect the fact that the thickness of the vapour deposition film 10b is significantly thinner than, or at least as thin as, the paper bulk layer 21a.

On the outside of the paper or paperboard layer 15, which will constitute the outside wall of a packaging container produced from the packaging laminate, is applied an outermost layer 26 of a heat-sealable polyolefin, preferably a low density polyethylene (LDPE) or a linear low density polyethylene (LLDPE), which may include also so-called metallocene-catalysed LLDPE's (m-LLDPE), i.e. LLDPE polymers catalysed by means of a single site catalyst.

It is to be understood that the packaging laminate shown in FIG. 2a should be seen as a mere example, from which the person skilled in the art will have no problems in deducing a variety of other embodiments. It is even conceivable that the packaging laminate may comprise two vapour deposition coated films according to the invention, although not necessarily being absolutely identical, one on each side of the bulk or core layer 21a.

The packaging laminate 20a according to the invention can be produced according to any suitable prior art principle known to the skilled person. Preferably, however, with reference to the laminate shown in FIG. 2a, the binding layer 24 may be extruded into a laminator nip, between the paper or paperboard bulk layer 21a and the pre-manufactured metallised film 10b. The metallised layer is preferably treated by flame, plasma or corona treatment before being laminated to the paper or paperboard bulk layer. Finally the outermost layer 26 of a heat-sealable polyolefin is extruded onto the paper or paperboard bulk layer 21a.

In FIG. 2b, the lamination process 20b is shown, wherein the paper or paperboard layer 21b is laminated to a vapour deposited substrate polymer film 23, having a thin vapour deposited coating 23a on the side facing towards the paper layer, by extruding an intermediate bonding layer of LDPE 24 from an extrusion station 24a and pressing together in a roller nip 25. In the case of a metallised vapour deposition coating, the contacting surface of the substrate film, or of the receiving layer, is pre-treated by a surface treatment (not shown) before pressing the layers together in the nip. Subsequently, the laminated paper and film passes a second extruder 27 and lamination nip 28, where an outermost heat sealable layer of LDPE 26 is coated onto the outer side of the paper layer. Finally, the finished packaging laminate 29 is wound onto a storage reel, not shown.

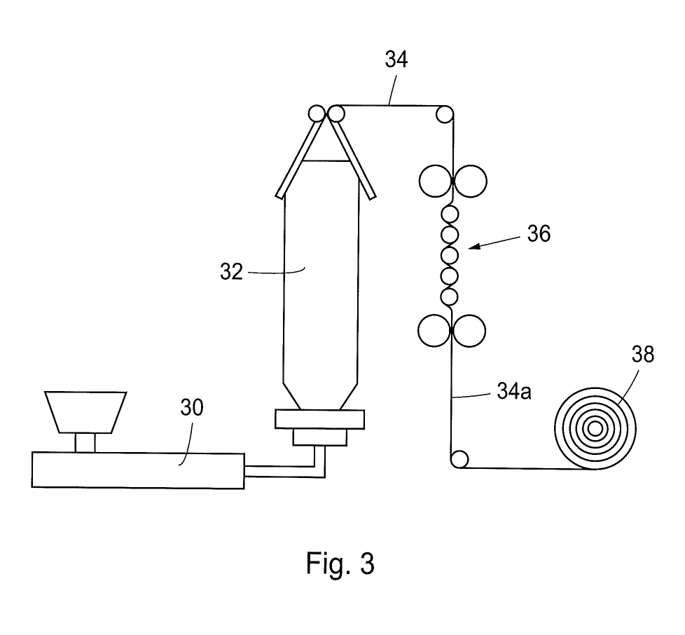

FIG. 3 is a diagrammatic view of a plant for (co-)extrusion blowing of an intermediate film, i.e. the substrate polymer film before being vapour deposition coated by a metal or by an inorganic metal compound. The one or more layers of the substrate polymer film are (co-)extruded from the extruder 30 and blown 32, to form a film 34 of relatively high thickness. Then, the film 34 is subjected to mono-axial orientation 36 between at least 10 multiple, non-driven, idle rollers, while it is hot, such that the thickness of the film is reduced 34a and the substrate polymer film becomes mono-oriented and gets a certain degree of stiffness due to a relatively higher degree of crystallinity than non-oriented polymer films. The resulting intermediate film is then heat stabilised at the end of the orientation step before it is wound to a roll 38. The temperature profile through the set of rollers is optimised for orientating the specific structure of the film to avoid curling or breaking of the web. Generally, the orientation temperature should be kept at a temperature at least some degrees below the melting temperature of the polymer to be orientated. Sufficient cooling is needed in order to heat stabilise the film at the end of the orientation and relaxation step, for successful subsequent further handling, coating and lamination. The film 34 has the form of a tube, when it exits the extrusion-blower 32, and may be opened/slit before being orientated. If necessary, two parallel orienters 36 may be used in that case. It is also possible to perform the orientating operation off-line from the film blower.

Other methods of forming the intermediate non-oriented film, such as co-extrusion casting e.g., are obvious to the person skilled in the art.

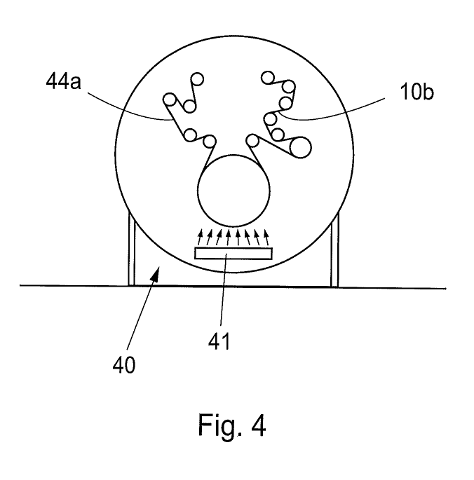

FIG. 4, is a diagrammatic view of an example of a plant for vapour deposition coating of the intermediate film produced in FIG. 3. The orientated film 34a from FIG. 3 is subjected, on the coating receiving side, to continuous evaporation deposition 40, of a metallised layer of aluminium, possibly in a mixture with aluminium oxide, and the coating is given a thickness of 5-100 nm, preferably 5-50 nm, so that the coated film 10b of the invention is formed. The aluminium vapour comes from a solid piece evaporation source 41.

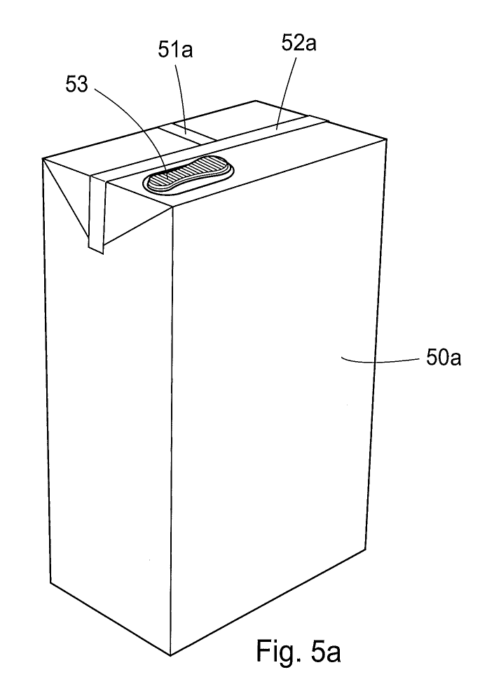

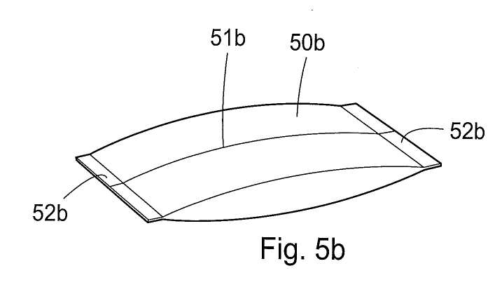

FIG. 5a shows a preferred example of a packaging container 50 produced from the packaging laminate 10a according to the invention. The packaging container is particularly suitable for beverages, sauces, soups or the like. Typically, such a package has a volume of about 100 to 1000 ml. It may be of any configuration, but is preferably brick-shaped, having longitudinal and transversal seals 51 and 52, respectively, and optionally an opening device 53. In another embodiment, not shown, the packaging container may be shaped as a wedge. In order to obtain such a “wedge-shape”, only the bottom part of the package is fold formed such that the transversal heat seal of the bottom is hidden under the triangular corner flaps, which are folded and sealed against the bottom of the package. The top section transversal seal is left unfolded. In this way the half-folded packaging container is still is easy to handle and dimensionally stable when put on a shelf in the food store or on a table or the like.

FIG. 5b shows an alternative, preferred example of a packaging container 50b produced from the packaging laminate 10b according to the invention. Since the packaging laminate 10b is thinner by having a thinner paper core layer, it is not dimensionally stable enough to form a parallellepipedic or wedge-shaped packaging container, and is not fold formed after transversal sealing 52b. It will thus remain a pillow-shaped pouch-like container and distributed and sold like this.

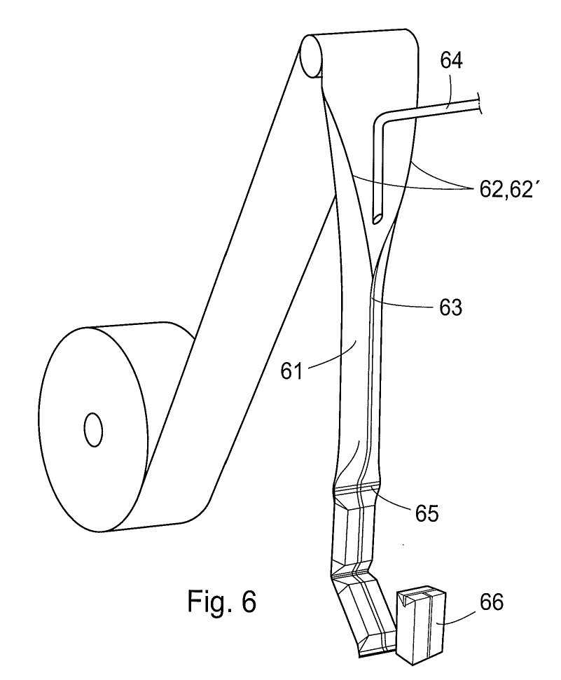

FIG. 6 shows the principle as described in the introduction of the present application, i.e. a web of packaging material is formed into a tube 61 by the longitudinal edges 62, 62′ of the web being united to one another in an overlap joint 63. The tube is filled 64 with the intended liquid food product and is divided into individual packages by repeated transversal seals 65 of the tube at a pre-determined distance from one another below the level of the filled contents in the tube. The packages 66 are separated by incisions in the transversal seals and are given the desired geometric configuration by fold formation along prepared crease lines in the material.

By way of conclusion it should be observed that the present invention which has been described above with particular reference to the accompanying drawings, is not restricted to these embodiments described and shown exclusively by way of example, and that modifications and alterations obvious to a person skilled in the art are possible without departing from the inventive concept as disclosed in the appended claims.

1. A thermo-mechanically stable, heat sealable, mono-axially oriented polymer substrate film, consisting essentially of polymers based on lower density polyethylenes, the polymer substrate film having a thickness of 20 μm or lower, shrink properties of 15% or lower, based on ASTM D 1204 at 80° C. measurement temperature, and a Young's Modulus of from 250 to 800 MPa.

2. A thermo-mechanically mono-axially oriented film according to claim 1, wherein the polymer substrate film consisting essentially of polymers based on low density polyethylene (LDPE) comprises from 75 to 100, weight-% of linear low density polyethylene (LLDPE).

3. A thermo-mechanically mono-axially oriented film according to claim 1, wherein the polymer substrate film is a film from multiple layers, which multiple layers each are mono-oriented in the same direction and to the same extent.

4. A thermo-mechanically mono-axially oriented film according to claim 1, wherein the polymer substrate film is oriented to a ratio of 2-7.

5. A thermo-mechanically mono-axially oriented film according to claim 1, wherein the film has an elongation at break lower than 400%.

6. A thermo-mechanically mono-axially oriented film according to claim 1, having a vapour deposition layer coated onto a first side of the substrate film.

7. A thermo-mechanically mono-axially oriented film according to claim 6, wherein the vapour deposition coated layer is a metallised layer.

8. A thermo-mechanically mono-axially oriented film according to claim 6, wherein the vapour deposition coated layer is a layer of vapour deposited aluminium or aluminium oxide.

9. A metallised thermo-mechanically mono-axially oriented film according to claim 7, wherein the metallised layer has an optical density (OD) of from 1.8 to 3.0.

10. A thermo-mechanically mono-axially oriented film according to claim 6, wherein the polymer substrate film has a receiving layer towards the vapour deposition coated layer, which receiving layer is mono-oriented in the same direction and to the same extent as any other layer(s) of the polymer substrate film.

11. A thermo-mechanically mono-axially oriented film according to claim 6, wherein the receiving layer comprises a polyethylene-based adhesive polymer modified by graft- or co-polymerisation with monomers comprising functional groups selected from the group consisting of acrylic acid groups, methacrylic acid groups or maleic anhydride groups.

12. A thermo-mechanically mono-axially oriented film according to claim 6, wherein the vapour deposition coated layer has an adhesion of at least 200 N/m.

13. A metallised thermo-mechanically mono-axially oriented film according to claim 7, wherein the film has an oxygen transmission rate lower than 100 cm3/(m2*24 h), 1 atm O2, 23° C., 50% RH.

14. A metallised thermo-mechanically mono-axially oriented film according to claim 7, wherein the film has a water vapour permeation rate of lower than 5, g/m2 at 38, and 23, ° C., 24 hours, at a gradient of from 0 to 90% RH.

15. A thermo-mechanically mono-axially oriented film according to claim 6, wherein the vapour deposition coated layer is a carbon-based layer.

16. A packaging laminate comprising a mono-axially oriented film, according to claim 1.

17. A packaging laminate according to claim 16, wherein the packaging laminate also comprises a paper or paperboard core layer.

18. A packaging laminate according to claim 16, wherein said heat sealable polymer substrate film forms a surface of the packaging laminate intended to form an interior surface of a package made from said packaging laminate.

19. A packaging container formed from a packaging laminate according to claim 16.

20. A method for the manufacturing of a thermo-mechanically stable, heat sealable, mono-axially oriented polymer substrate film, which method comprises:
a) forming a polymer substrate film from one or multiple layers consisting essentially of polymers based on low density polyethylene, by an extrusion manufacturing method, and
b) mono-axially stretching the polymer substrate film to a ratio of 2-7, and to a thickness of below 20 μm.

21. A method for the manufacturing of a vapour deposition coated, thermo-mechanically stable, mono-axially oriented film comprising a vapour deposition coated layer and a heat sealable polymer substrate film, which method comprises:
a) forming a polymer substrate film from one or multiple layers consisting essentially of polymers based on low density polyethylene, by an extrusion manufacturing method,
b) mono-axially stretching the polymer substrate film to a ratio of 2-7, and to a thickness of below 20 μm,
c) surface treating a first side of the polymer substrate film, and subsequently,
d) vapour depositing a barrier layer from an inorganic or organic compound onto the first side of the film, which has been subject to said surface treatment.

22. A method according to claim 20, wherein a thickness of the polymer substrate film is reduced by up to 75%, by said stretching.

23. A method according to claim 20, wherein the elongation at break of the polymer substrate film is reduced to lower than 400%, by said stretching.

24. A method according to claim 20, wherein the Young's Modulus of the polymer substrate film is increased to a value of from 250 to 800, by said stretching.

25. A method according to claim 20, wherein the step of mono-axially stretching the polymer substrate film is carried out by a combined orientation and relaxation method involving more than 10, orientation roller nips, of which first and last nips include driven rollers and the rollers between the first and the last orientation roller nips are non-driven, idle rollers.

26. A method according to claim 20, wherein the vapour deposition coated layer is a metallised layer.

27. A method according to claim 26, wherein the metallised layer is vapour deposited to an optical density (OD) of from 1.8 to 3.0.

28. A method according to claim 20, wherein the polymer substrate film has a receiving layer towards the vapour deposition coated layer, which receiving layer preferably comprises a polyethylene-based adhesive polymer modified by having functional groups selected from the group consisting of acrylic acid groups, methacrylic acid groups or maleic anhydride groups, and which receiving layer is mono-oriented in the same direction and to the same extent as the other layer(s) of the polymer substrate film.

29. A method according to claim 20, wherein the first side of the polymer substrate film or the receiving layer is surface treated by plasma surface treating.

30. A method according to claim 28, wherein the rollers used on the receiving layer side of the polymer substrate film in the mono-axial orientation step are provided with a non-stick coating for improved orientation and relaxation during the mono-axial orientating step b).

31-33. (canceled)
